(19) United States
(12) Patent Application Publication
(10) Pub. No.: US 2015/0355405 A1
(43) Pub. Date: Dec. 10, 2015

(54) TECHNIQUES AND APPARATUS FOR ILLUMINATING ARTICLES AND/OR GRAPHIC CONTENT

(71) Applicant: T+Ink, Inc., New York, NY (US)

(72) Inventors: John Gentile, Montclair, NJ (US); Anthony Gentile, New York, NY (US); Ronald H. Haag, Lake Orion, MI (US); Terrance Z. Kaiserman, Loxahatchee, FL (US); Tayler Kaiserman, Brooklyn, NY (US); Andrew R. Ferber, New York, NY (US)

(73) Assignee: T+Ink, Inc., New York, NY (US)

(21) Appl. No.: 14/576,838

(22) Filed: Dec. 19, 2014

Related U.S. Application Data
(60) Provisional application No. 61/918,632, filed on Dec. 19, 2013.

(51) Int. Cl. F21V 8/00; G09F 13/02

(52) U.S. Cl. CPC G02B 6/0088; G02B 6/0083; G09F 13/02

(57) ABSTRACT

Techniques and apparatus for emitting light. A light-emitting system is disclosed. The light-emitting system may include a light source and a light guide. The light guide may be configured to receive and emit at least a portion of the light emitted by the light source.

### RELATED APPLICATIONS

This application claims priority to U.S. Provisional Application No. 61/918,632, filed Dec. 19, 2013 which is incorporated herein by reference in its entirety.

### BACKGROUND

1. Field

The present disclosure relates to techniques and apparatus for illuminating articles and/or graphic content. Some embodiments relate specifically to using light guides to illuminate articles and/or graphic content (e.g., printed publications).

2. Related Art

Light includes electromagnetic radiation in the visible portion of the electromagnetic spectrum, which includes wavelengths ranging at least from about 400 nm to about 700 nm. Light also includes electromagnetic radiation in the infrared and ultraviolet portions of the spectrum. Light guides are structures that may be used to guide the propagation and emission of light in the infrared, ultraviolet, and/or visible portions of the spectrum.

### SUMMARY

According to an aspect of the present disclosure, a light-emitting system is provided, comprising a light source, a power source configured to provide power to the light source, a light guide configured to receive and emit at least a portion of the light emitted by the light source, and a layer disposed adjacent to the light guide and comprising a material defining a graphic image.

According to an aspect of the present disclosure, a multi-layer system for illuminating graphic content is provided, the system comprising a first layer, a second layer including graphic content, the second layer at least partially overlaying and attached to the first layer, and a light guide configured to receive light emitted by a light source positioned between the first layer and the second layer, and to at least partially illuminate the graphic content by emitting at least a portion of the light.

According to an aspect of the present disclosure, a light-emitting system is provided, comprising an article having a contoured external surface, a light source, a light guide at least partially overlaying at least a portion of the article and having a shape that substantially matches the contour of the external surface of the underlying article, the light guide configured to receive and emit at least a portion of the light emitted by the light source, and a switch configured such that, when the switch is in a first state, the light guide emits light of a first color and, when the switch is in a second state, the light guide emits light of a second color.

According to an aspect of the present disclosure, a light-emitting system is provided, comprising an article having a contoured external surface, and a light guide at least partially overlaying at least a portion of the article and having a shape that substantially matches the contour of the external surface of the underlying article, the light guide configured to receive and emit at least a portion of the light emitted by a light source integrated with the light guide.

According to an aspect of the present disclosure, a light-emitting system is provided, comprising a light source, and a light guide configured to receive and emit at least a portion of the light emitted by the light source, wherein the light guide emits light from a substantially planar emission surface in the form of a graphic defined, at least in part, by a light-inhibiting material disposed adjacent to at least a portion of the emission surface.

According to an aspect of the present disclosure, a light-emitting system is provided, comprising a light source, and a flexible light guide having an average thickness of less than or equal to about 5 mm and configured to receive and emit at least a portion of the light emitted by the light source. Some embodiments of a light-emitting system are not limited by a thickness of the light-emitting system.

According to an aspect of the present disclosure, a light-emitting system is provided, comprising a light source, and a formable light guide having an average thickness of less than or equal to about 5 mm and configured to receive and emit at least a portion of the light emitted by the light source. Some embodiments of a light-emitting system are not limited by a thickness of the light-emitting system.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a light-emitting system, in accordance with some embodiments;

FIG. 2 is a perspective view of another light-emitting system, in accordance with some embodiments;

FIG. 3 is a block diagram of another light-emitting system, in accordance with some embodiments;

FIG. 4 is a perspective view of an output unit, in accordance with some embodiments;

FIG. 5 is a schematic of another light-emitting system (e.g., a light-emitting system that forms a portion of a printed publication), in accordance with some embodiments;

FIG. 6 is a perspective view of another light-emitting system, in accordance with some embodiments; and

FIG. 7 is a block diagram illustrating an exemplary computing device on which aspects of the present disclosure may be implemented.

### DETAILED DESCRIPTION

The inventors have appreciated that conventional techniques for illuminating articles and/or graphic content have become increasingly inadequate in a competitive economy. Advertisers, retailers, service-providers, manufacturers, writers, and others (collectively, “providers”) compete for the attention and interest of people who are increasingly inundated with information at nearly all times and in nearly all places via ubiquitous electronic devices and tangible publications (e.g., printed publications). Functional or decorative illumination of an item (e.g., an article or graphic content) can help the item stand out from the crowded field of items competing for a person's attention and interest.

For example, eye-catching graphic content in a printed publication, such as an advertisement, may pique a reader's interest in the content of the printed publication, thereby giving the content provider an advantage in the competition for the reader's attention. The inventors have appreciated that the appearance and/or function of graphic content in a printed publication may be improved by including a light guide in the printed publication. When a light guide is included in a printed publication, the light guide may manipulate light in ways that catch a reader's eye, hold a reader's attention, or encourage the reader to consider or interact with the content of the printed publication.

In some embodiments, a printed publication or portion thereof (e.g., a page of the printed publication) may comprise a system for illuminating graphic content (e.g., the graphic content of an advertisement). The system may include a light source, such as one or more light-emitting diodes (LEDs). In addition, the system may include a power source, such as one or more flat batteries, configured to power the light source. The system may also include a light guide configured to receive and emit light emitted by the light source. In some embodiments, the light guide may be thin and flexible. For example, the light guide may be flexible enough to bend, twist, and roll to an extent consistent with routine handling of conventional printed publications. In some such embodiments, the light guide's thickness may be on the order of a few millimeters or less. The system may also include a computing device and/or an input unit (e.g., one or more switches or sensors) which may be powered by the power source and configured to control the light source. In some embodiments, the light guide, light source, power source, computing device, and/or input unit may be included in (e.g., etched or printed on) one or more layers of a structure, such as a thin film structure.

The system may include one or more layers disposed adjacent to the light guide. For example, the system may include a first layer and a second layer overlaying the first layer, with the light source positioned between the first and second layers, and the light guide configured to illuminate graphic content on the first and/or second layer. The second layer may be attached to the first layer, such that the first and second layers surround and encapsulate the light guide. A page of the printed publication may correspond to outer surfaces of the first and second layers.

However, conventional light guides are increasingly inadequate for illuminating articles and/or graphic content. The inventors have appreciated that improved decorative and functional illumination may be improved by using thin, flexible light guides to control the emission of light.

The various aspects described above, as well as further aspects, will now be described in detail below. It should be appreciated that these aspects may be used alone, all together, or in any combination of two or more, to the extent that they are not mutually exclusive.

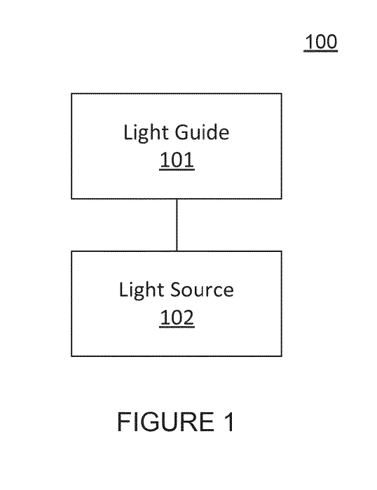

FIG. 1 illustrates a light-emitting system 100, in accordance with some embodiments. Light-emitting system 100 may be configured to emit light using a light source 102 and a light guide 101. In some embodiments, light source 102 may be configured to emit light of a single wavelength (e.g., color), one or more wavelengths, multiple wavelengths, and/or any color. In some embodiments, light source 102 may include one or more light-emitting components, including, but not limited to, electroluminescent devices, light-emitting diodes (LEDs), organic LEDs, polymer LEDs, light-emitting polymers, and/or any other suitable material or structure capable of emitting light. In some embodiments, a light-emitting component may be configured to emit light of a set of fixed wavelength(s) (e.g., color). Such light-emitting components may be referred to as “single-wavelength” light-emitting components. In some embodiments, a light-emitting component may be configured to emit light of different wavelengths under different conditions. Such light-emitting components may be referred to as “multi-wavelength” light-emitting components.

In some embodiments, light source 102 may comprise a side-fired LED disposed on a thin substrate. In some embodiments, a light source 102 may comprise one or more quantum dots (e.g., one or more quantum dots configured to alter the color saturation of an LED). In some embodiments, a light source 102 may comprise an LED configured to emit light of an ultraviolet wavelength.

Light source 102 may be configured to control properties of the light emitted by the light source. Properties of emitted light that are controlled by light source 102 may include, but are not limited to, the light's wavelength, color, intensity, luminance, and/or chromaticity. In some embodiments, light source 102 may be configured to control properties of the light's color, including, but not limited to, the color's hue, tint, shade, tone, saturation, and/or lightness. Any suitable technique for controlling the properties of the light and/or the light's color may be used, including, but not limited to, varying properties of electrical signals applied to the light source's light-emitting components. For example, properties of the light emitted by light source 102 and/or the light's color may depend on the amplitude, phase, or frequency of voltages or currents applied to the light source's light-emitting components.

As just one example, light source 102 may be configured to control one or more light-emitting components to emit first light of a first color and second light of a second color, thereby producing light which is perceivable (e.g., to the human eye) as having a color different from a color of the first light and different from a color of the second light. In some embodiments, light source 102 may include light-emitting components configured to emit, respectively, red, green, and blue light. Light source 102 may be configured to control properties of the emitted light and/or the light's color by controlling the electrical signals applied to the red, green, and blue light-emitting components. In some embodiments, light source 102 may include light-emitting components configured to emit, respectively, cyan, magenta, and yellow light. Light source 102 may be configured to control properties of the emitted light and/or the light's color by controlling the electrical signals applied to the cyan, magenta, and yellow light-emitting components.

Light guide 101 may be configured to receive, guide, and emit light. In some embodiments, light guide 101 may be configured to receive at least a portion of the light emitted by light source 102, and to emit at least a portion of the received light. Light guide 101 may include one or more plastics (e.g., thermoplastics), polymers (e.g., polycarbonate, polyethylene, polyurethane, polyester, polyvinylchloride), blends of two or more polymers (e.g., a blend of polycarbonate and polyethylene), thermo-formable materials, materials that maintain shape after being exposed to heat and/or pressure, and/or any other material suitable for guiding light.

In some embodiments, light guide 101 may be flexible and/or elastic. A flexible and/or elastic light guide may be configured to bend and/or twist to accommodate routine handling of a magazine or newspaper without breaking or tearing. For example, the Young's modulus of light guide 101 may be less than 0.01 Gpa, between 0.01 GPa and 0.1 GPa, or between 0.1 GPa and 1.0 GPa. In some embodiments, the Young's modulus of light guide 101 may be between 1.0 GPa and 100 GPa, between 100 GPa and 1,000 GPa, or greater than 1,000 GPa. In certain embodiments, the Young's modulus of light guide 101 may be at least 0.001 GPa, at least 0.01 GPa, at least 0.1 GPa, at least 1 GPa, and/or less than 1,000 GPa, less than 100 GPa, or less than 10 GPa.

In some embodiments, light guide 101 may be moldable (e.g., capable of maintaining a molded shape) and/or formable (e.g., capable of maintaining a formed shape). For example, light guide 101 may be plastically deformable in response to application of sufficient force and/or heat.

Light guide 101 may have any suitable shape. In some embodiments, light guide 101 may be substantially flat. A “substantially flat” object may include any object having two opposing, substantially planar surfaces that are substantially parallel. Two surfaces may be substantially parallel when an angle between the surfaces is less than 5°, 3°, 2°, or 1°. One of ordinary skill in the art would be capable of determining the planarity of a surface by aligning the edges of the surface such that the edges are horizontal, scanning the area of the surface, and measuring deviations in surface height. Substantially planar surfaces may include those surfaces which have maximum deviations in surface height (measured as the difference between the lowest and highest points on the surface) of less than 5 mm in some embodiments and less than 1 mm in some embodiments. In some embodiments, a substantially planar surface does not include any deviations in surface height of greater than 5 mm in some embodiments or greater than 1 mm in some embodiments.

In some embodiments, a light guide 101 or portions thereof may not be substantially flat. In some embodiments, a portion of light guide 101 may form a cavity having a depth of at least 5 mm relative to an adjacent portion of a surface of light guide 101. In some embodiments, a portion of light guide 101 may form a protrusion having a height of at least 5 mm relative to an adjacent portion of a surface of light guide 101.

In some embodiments, a ratio between the light guide's dimension in a first direction and the light guide's dimension in a second direction orthogonal to the first direction may be at least 5:1, 10:1, 20:1, 50:1, 100:1, or 1,000:1, and a ratio between the light guide's dimension in the first direction and the light guide's dimension in a third direction mutually orthogonal to the first and second directions may be at least 5:1, 10:1, 20:1, 50:1, 100:1, or 1,000:1. For example, the ratio of a light guide's length to its thickness, and the ratio of the light guide's width to its thickness, may both be at least 5:1, 10:1, 20:1, 50:1, 100:1, or 1,000:1.

In some embodiments, light guide 101 may be thin. For example, light guide 101 may have an average thickness less than or equal to approximately 5 mm, 3 mm, 2 mm, 1 mm, or 0.5 mm, and greater than or equal to approximately 0.1 mm. In some embodiments, light guide 101 may have an average thickness between 5 mm and 125 mm, or an average thickness greater than 125 mm. In some embodiments, the thickness of light guide 101 is non-limiting. The average thickness of an article, including, but not limited to a light guide and/or a light-emitting system, may be calculated by measuring the thickness of the article at a statistically representative number of locations and calculating the number average of the measurements.

A cross-section of a portion of light guide 101 may have any suitable shape. In some embodiments, a portion of light guide 101 may be rectangular in cross-section. In some embodiments, at least a portion of a periphery of a cross-section of a portion of light guide 101 may be curved. In some embodiments, different portions of light guide 101 may have differently shaped cross sections.

Light guide 101 may have one or more surfaces. In some embodiments, light guide 101 may be a rectangular prism. One or more of the light guide's surfaces may be optically transmissive. For example, one or more of the light guide's surfaces may have an optical transmittance greater than or equal to approximately 70%, 80%, 90%, 95%, or 99% for optical signals in the visible spectrum. One or more of the light guide's surfaces may be optically opaque. For example, one or more of the light guide's surfaces may have an optical transmittance less than or equal to approximately 30%, 20%, 10%, 5%, or 1% for optical signals in the visible spectrum.

In some embodiments, the transmittance of a surface of light guide 101 may be at least partially determined by the presence of one or more light-inhibiting materials on the light guide's surface. Light-inhibiting materials may include any materials which tend to inhibit the transmission of light therethrough. In some embodiments, a light-inhibiting material may have an optical transmittance between 70% and 50%, between 50% and 30%, between 30% and 20%, between 20% and 10%, between 10% and 5%, between 5% and 1%, between 1% and 0.1%, or less than 0.1%. In some embodiments, a light-inhibiting material may have an optical transmittance of less than 70%, less than 50%, less than 30%, less than 20%, less than 10%, less than 5%, or less than 1% and/or, in certain embodiments, at least 0.001%, at least 0.01%, and/or at least 0.1%. Examples of light-inhibiting materials may include, but are not limited to, ink (e.g., aluminum ink), glass, or polymers. In some embodiments, light-inhibiting materials may be printed on a surface of a light guide, deposited on a surface of a light guide, or attached to the surface of a light guide using any other suitable technique. Some light-inhibiting materials may be configured to reflect light from a surface of a light guide back into an interior portion of the light guide.

Light guide 101 may be manufactured using any suitable manufacturing technique. In some embodiments, light guide 101 may be molded, printed, extruded, etched (e.g., laser etched), and/or stamped.

Light guide 101 may be configured to control the distribution of light emitted by the light guide. In some embodiments, light guide 101 may be configured to substantially uniformly illuminate one or more portions of the light guide (e.g., one or more surfaces of the light guide) with light received from light source 102. A portion of light guide 101 may be substantially uniformly illuminated when one or more of the light's properties exhibit an average variation of less than 20%, 10%, 5%, or 1% over that portion of the light guide. For example, a portion of light guide 101 may be substantially uniformly illuminated when the light's color, intensity, luminance, and/or chromaticity exhibit average variation of less than a threshold percentage over that portion the light guide.

In some embodiments, light guide 101 may be configured to emit light having first properties (e.g., a first wavelength and/or color) from a first region of the light guide (e.g., a surface of the light guide, multiple surfaces of the light guide, a portion of a surface of the light guide, portions of a surface of the light guide, and/or portions of multiple surfaces of the light guide). In some embodiments, light guide 101 may be configured to emit light having first properties (e.g., a first wavelength and/or a first color) from a first region of the light guide and configured to emit light having second properties (e.g., a second wavelength and/or a second color) from a second region of the light guide. In some embodiments, light guide 101 may be configured to emit light having first properties (e.g., a first wavelength and/or a first color) from a cavity and/or protrusion of the light guide and to emit light having second properties (e.g., a second wavelength and/or a second color) from another portion of the light guide.

Light guide 101 may be optically coupled to light source 102 using any suitable technique. In some embodiments, light source 102 may be adjacent to light guide 101, enclosed in light guide 101, in contact with light guide 101, or otherwise configured to transmit light to light guide 101. In some embodiments, at least portions of light guide 101 and light source 102 may be integrated in a same structure (e.g., formed in a same layer of material, or formed in one or more layers of a same multi-layer structure). In some embodiments, light source 102 may be configured to transmit light to light guide 101 through an ambient medium, such as air. In some embodiments, light source 102 may be configured to transmit light to light guide 101 via an optical waveguide.

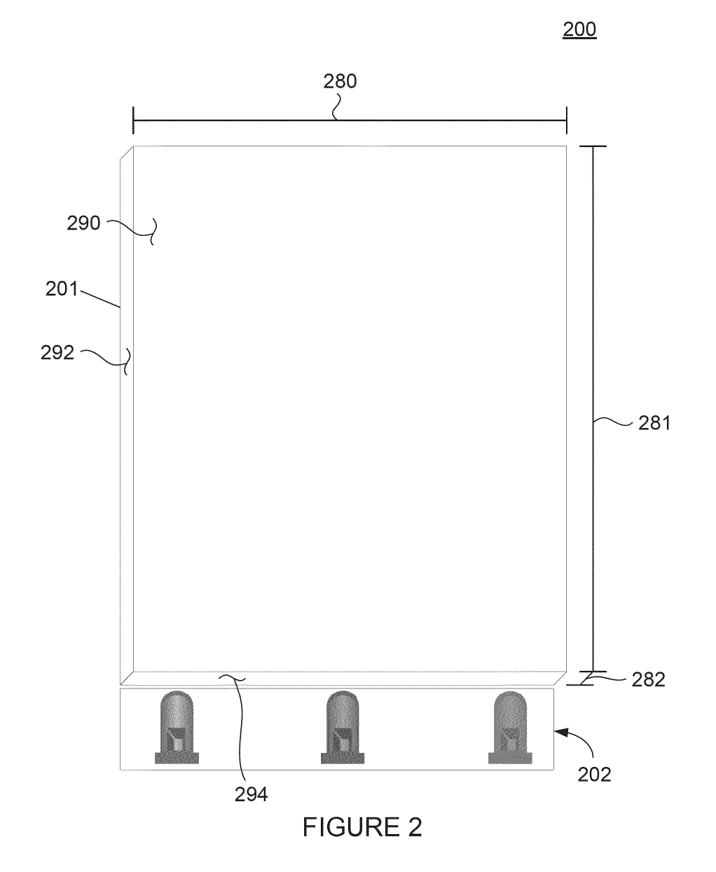

FIG. 2 illustrates a light-emitting system 200, in accordance with some embodiments. Light-emitting system 200 may be configured to emit light using a light source 202 and a light guide 201. In the example of FIG. 2, light source 202 includes three light-emitting components, which may be, for example, a red LED, a green LED, and a blue LED. By controlling the activation of the light-emitting components and properties of the light emitted by the light-emitting components, light source 202 may determine the intensity, wavelength, color, luminance, and/or chromaticity of the light transmitted from light source 202 to light guide 201.

In the example of FIG. 2, light guide 201 has a width 280, a length 281, and a thickness 282. In embodiments where the ratio of thickness 282 to width 280 is less than a suitable threshold (e.g., 1:10) and the ratio of thickness 282 to length 281 is less than a suitable threshold (e.g., 1:10), light guide 201 may be substantially flat.

In the example of FIG. 2, light guide 201 includes optically transmissive surfaces 290 and 294, as well as optically opaque surface 292. Light guide 201 receives light from light source 202 through transmissive surface 294 and/or transmissive surface 290, and emits light through transmissive surface 290. The light emitted through surface 290 may be substantially uniformly distributed across surface 290, or across a portion of surface 290. In some embodiments, a pattern may be etched or printed on light guide 201 to facilitate the substantially uniform distribution of light emitted through surface 290. A light-inhibiting material (e.g., white aluminum ink, or a suitable film) may be disposed on opaque surface 292 to inhibit transmission of light from light guide 201 to the ambient environment via surface 292, and/or to reflect light away from surface 292. In some embodiments, transmissive surface 290 may be substantially planar.

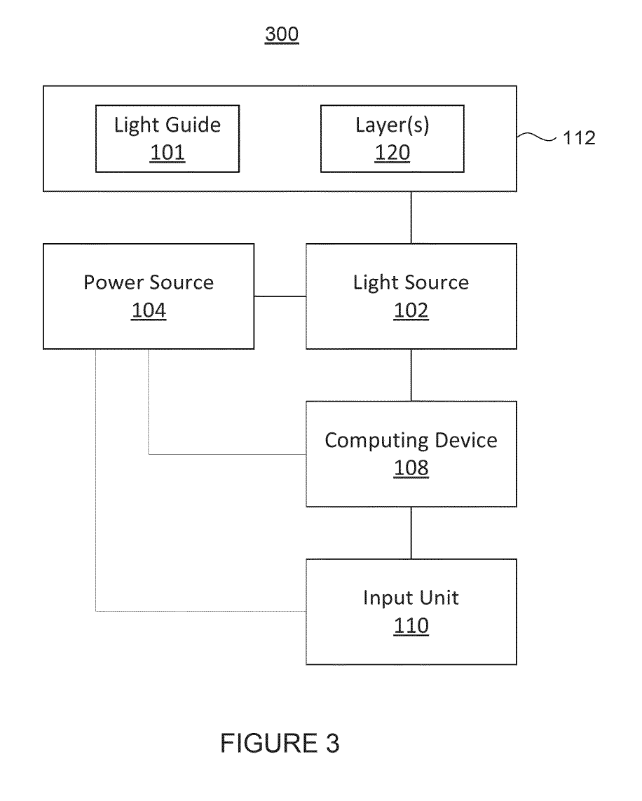

FIG. 3 illustrates a light-emitting system 300, in accordance with some embodiments. Light-emitting system 300 may be configured to emit light and may include a light source 102 and an output unit 112. In some embodiments, light-emitting system 300 may include a power source 104, a computing device 108, and/or an input unit 110. Output unit 112 may include a light guide 101. In some embodiments, output unit 112 may include one or more layers 120. These components are discussed in turn below.

In some embodiments, one or more components of light-emitting system 300 may comprise and/or be at least partially formed from one or more conductive inks. In some embodiments, conductive connections (e.g., wires, traces, and/or vias) between components may comprise and/or be at least partially formed from one or more conductive inks. In some embodiments, light-emitting system 300 may include a light-inhibiting material, and such light-inhibiting material may comprise and/or be formed from one or more conductive inks. In some embodiments, a conductive ink may comprise a conductive material that may be formed by the evaporation and/or curing of a binder/carrier liquid in which a conductive material is suspended. Examples of conductive inks may include, but are not limited to, metallic inks, such as aluminum ink.

Power source 104 may be configured to provide power (e.g., electrical power) to one or more components of light-emitting system 300. In some embodiments, power source 104 may include one or more batteries (e.g., flat batteries, printed batteries, primary cell or non-rechargeable batteries, secondary cell or rechargeable batteries), one or more photovoltaic cells, and/or any other component suitable for providing energy (e.g., electrical energy) and/or for converting one or more types of energy (e.g., solar energy, mechanical energy, or chemical energy) into another type of energy (e.g., electrical energy). In some embodiments, power source 104 may include a component configured to convert the mechanical energy of a bicycle into electrical energy (e.g., a bicycle generator).

Power source 104 may provide power to one or more components of light-emitting system 300 using any suitable technique. In some embodiments, power source 104 may be coupled to a component of light-emitting system 300 (e.g., light source 102, computing device 108, and/or input unit 110) by any coupling suitable for transmitting power, including, but not limited to, an electrical coupling, electronic coupling, electromagnetic coupling, optical coupling, and/or mechanical coupling. Power source 104 may be configured to transmit power to a component of light-emitting system 300 via such a coupling. In some embodiments, power source 104 may be coupled to a component of light-emitting system 300 by electrical conductors (e.g., wires, traces, and/or vias comprising one or more electrically conductive materials, such as metallic material, polysilicon, or conductive ink), and may be configured to transmit power to the component by propagating electrical signals through the electrical conductors. In some embodiments, power may be transmitted wirelessly from power source 104 to a component of light-emitting system 300 by propagating electromagnetic signals (e.g., optical signals or radio-frequency signals) through the ambient environment. For example, power source 104 may include an oscillator configured to generate an electromagnetic field in the radio-frequency band. Power source 104 may be coupled to a component of light-emitting system 300 by the electromagnetic field, and may be configured to use the electromagnetic field to provide power to the component via electromagnetic induction.

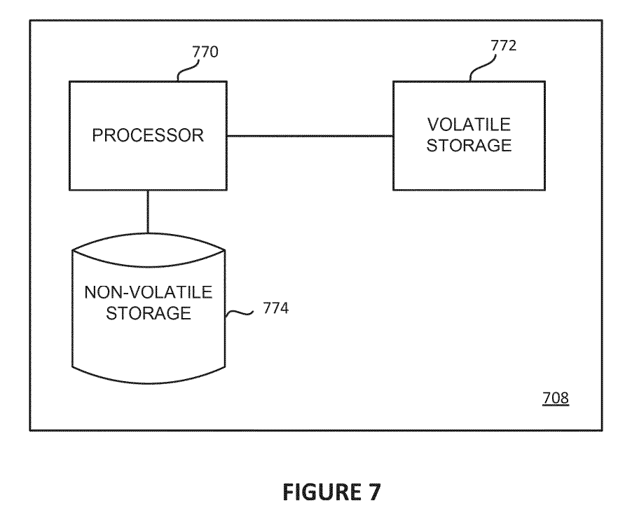

Computing device 108 may be configured to control operation of light source 102. In some embodiments, computing device 108 may control the light source's operation by applying signals (e.g., electrical signals) to the light source. In some embodiments, computing device 108 may control the light source's operation in response to signals received from input unit 110. Computing device 108 may be communicatively coupled to input unit 110 and/or light source 102 using any suitable technique, including, but not limited to, mechanical coupling, electrical coupling, electromagnetic coupling, optical coupling, wired coupling, and/or wireless coupling). Some embodiments of computing device 108 are discussed below with reference to FIG. 7.

Input unit 110 may be configured to acquire information (e.g., information provided by a user, information received via a computer network, and/or information obtained from the environment in which light emitting system 300 is disposed), and to provide signals to computing device 108 based, at least in part, on the acquired information. The signals provided to computing device 108 may, for example, encode the acquired information and/or encode commands derived from the acquired information. In some embodiments, input unit 110 may be integrated in a same structure with light source 102, power source 104, and/or computing device 108.

In some embodiments, input unit 110 may include one or more switches. Any suitable switch may be used, including, but not limited to, a capacitive switch, a membrane switch, a low-force membrane switch, a force-sensitive resistance switch, a multi-layer switch (e.g., including conductive layers and spacers), a dome switch, a discrete switch, a pressure-based switch, an optical switch, a proximity switch and/or a mechanical switch (e.g., a button or a DIP switch). In some embodiments, a switch (e.g., a capacitive switch) may be part of or attached to a rigid, semi-rigid, or flexible structure, such as a printed circuit board. In some embodiments, a switch (e.g., a capacitive switch) may be printed on, deposited on, or otherwise attached to a film. In some embodiments, a switch (e.g., a capacitive switch) may comprise a conductive ink. In some embodiments, input unit 110 may be configured to provide one or more signals to computing device 108 in response to activation or deactivation of one or more respective switches.

In some embodiments, input unit 110 may include one or more sensors. Any suitable sensor may be used, including, but not limited to, a motion sensor, a proximity sensor, a pressure sensor, a humidity sensor, a temperature sensor, an acoustical sensor, an optical sensor, a capacitive sensor, and/or any other sensor suitable for detecting an attribute of an environment. In some embodiments, a sensor may be configured to detect optical signals (e.g., ultra-violet light, visible light, or infrared light), acoustical signals (e.g., sound), electromagnetic signals (e.g., radio-frequency signals), and/or any other suitable stimuli. In some embodiments, input unit 110 may be configured to provide one or more signals to computing device 108 in response to detection of suitable stimuli.

Computing device 108 may control emission of light by light source 102. In some embodiments, computing device 108 may control emission of light by light source 102 in accordance with software executed by the computing device, and/or in response to signals received from input unit 110. In response to receiving a signal indicating activation of a switch, deactivation of a switch, and/or detection of a suitable stimulus, computing device 108 may activate or deactivate light source 102, and/or control light source 102 to change one or more properties of the light emitted by the light source. For example, in response to activation of a first switch, computing device 108 may control light source 102 to emit light of a first wavelength and/or color, and in response to activation of a second switch, computing device 108 may control light source 102 to emit light of a second wavelength and/or color.

Output unit 112 may be configured to provide illumination. In some embodiments, output unit 112 may include a light guide 101 and one or more layers 120. The one or more layers 120 may be configured to transmit and/or inhibit transmission of light emitted by light guide 101.

In some embodiments, a layer 120 may be disposed adjacent to one or more surfaces of light guide 101. A layer 120 may be adjacent to a surface of light guide 101 if a distance (e.g., average distance, minimum distance, or maximum distance) between the light guide's surface and the layer is less than a threshold distance (e.g., 1 m, 1 cm, 1 mm, or 0.1 mm), or if the light guide's surface is configured to emit light that reaches the layer. A layer 120 may be directly adjacent to a surface of light guide 101 if the layer is in contact with the surface, or if the light guide's surface is configured to emit light that reaches the layer's surface without passing through or reflecting off an intervening structure.

One or more layers 120 may be arranged at any suitable positions and/or in any suitable orientations with respect to light guide 101. In some embodiments, one or more layers 120 may be disposed over, above, under, and/or below light guide 101. In some embodiments, two or more layers 120 may be disposed such that at least some of the light emitted by light guide 101 passes through each of the two or more layers 120. In some embodiments, the two or more layers 120 may form a stack of layers or a multi-layer structure.

In some embodiments, one or more layers 120 may at least partially enclose light guide 101, light source 102, power source 104, computing device 108, and/or input unit 110. In some embodiments, one or more layers 120 enclosing light guide 101, light source 102, power source 104, computing device 108, and/or input unit 110 may form the front and back surfaces of a tangible publication or a portion thereof, such that the tangible publication or portion thereof comprises light-emitting system 300 or components thereof. A tangible publication may include, but is not limited to, a printed publication, magazine, newspaper, book, brochure, advertisement, flyer, journal and/or other collection of one or more tangible pages. A portion of a tangible publication may include, but is not limited to, a set of pages of the tangible publication, a page of the tangible publication, or a portion of a page of the tangible publication. A tangible page may include, but is not limited to, a layer of material with graphic content disposed on at least a portion of a surface of the layer, and/or a printed page.

A layer 120 may include any suitable material, including, but not limited to, plastic, paper, and/or polymer material. In some embodiments, a layer 120 may be a film (e.g., a thin film). In some embodiments, a film (e.g., thin film) may include a layer of any material having an average thickness less than approximately 0.030″, between 0.030″ and 0.010″, between 0.010″ and 0.001″, or less than 0.001″. In some embodiments, a film (e.g., thin film) may comprise a monomolecular layer. In some embodiments, a layer 120 may comprise transparent, opaque, and/or half-tone substances (e.g., light-inhibiting materials, such as light-inhibiting inks), which may form, respectively, transparent, opaque, and/or shaded regions. A region of a layer 120 may be transparent if the region has an optical transmittance greater than or equal to approximately 70%, 80%, 90%, 95%, 99%, or 99.9% for optical signals in the visible spectrum. A region of layer 120 may be opaque if the region has an optical transmittance less than or equal to approximately 30%, 20%, 10%, 5%, or 1% for optical signals in the visible spectrum. A region of layer 120 may be shaded if the region has an optical transmittance between approximately 1%, 5%, 10%, 20%, or 30% (on the low end of the range) and approximately 70%, 80%, 90%, 95%, or 99% (on the high end of the range) for optical signals in the visible spectrum.

In some embodiments, one or more layers 120 may include graphic content (e.g., a graphic image). The graphic content may be formed by one or more transparent regions, opaque regions, and/or shaded regions. In some embodiments, the graphic content may be defined, at least in part, by at least one transparent or shaded region of a layer 120. In some embodiments, light emitted from light guide 101 may illuminate the graphic content (e.g., by propagating through the transparent and/or shaded regions that form the graphic content). In some embodiments, the graphic content defined by a first of the layers 120 may differ from the graphic content defined by a second of the one or more layers 120. In some embodiments, the graphic content defined by a first layer of a stack of layers 120 may differ from the graphic content defined by a second layer of the stack of layers 120.

In some embodiments, the graphic content may be defined, at least in part, by the wavelength(s) of light emitted from light guide 101. In some embodiments, a portion of the graphic content may be visible only when the graphic content is illuminated by light of one or more particular wavelengths. In some embodiments, a portion of the graphic content may be invisible when the graphic content is illuminated by light of one or more particular wavelengths. Thus, in some embodiments, a sequence of different graphic content may be displayed by illuminating one or more layers 120 with a sequence of different wavelengths of light. Techniques for rendering graphic content visible when illuminated by light of a first wavelength and invisible when illuminated by light of a second wavelength may include, but are not limited to, forming selectively-transparent regions on one or more layers 120 (e.g., by printing or depositing ultraviolet ink), and configuring a light source 102 to illuminate the selectively-transparent region with light that renders the selectively-transparent region visible (e.g., ultraviolet light). In some embodiments, selectively-transparent regions may be formed using materials other than ultraviolet ink. In some embodiments, selectively-transparent regions may be rendered visible using light other than ultraviolet light.

In some embodiments, the perceived color of graphic content may depend, at least in part, on the color(s) of light emitted from light guide 101. In some embodiments, a portion of the graphic content may appear to have a first color when illuminated by light of a second color, and the portion of the graphic content may appear to have a third color when illuminated by light of a fourth color. Techniques for rendering the perceived color of graphic content dependent on the color of light emitted by light guide 101 may include, but are not limited to, forming regions of transparent color on one or more layers 120 (e.g., by printing or depositing ink or other material having a transparent color).

In some embodiments, the graphic content displayed by illuminating a stack of two or more layers 120 may depend on the wavelength(s) of light emitted by light guide 101. Thus, in some embodiments, a sequence of different graphic content may be displayed by illuminating a stack of two or more layers 120 with a sequence of different wavelengths of light.

In some embodiments, one or more non-transmissive surfaces of light guide 101 may be at least partially covered by a layer 120 to reflect light into an interior of the light guide and/or to prevent emission of light from the non-transmissive surface. In some embodiments, a layer 120 covering a non-transmissive surface of light guide 101 may include one or more opaque regions, including, but not limited to, one or more opaque regions having a white color.

In some embodiments, transparent, opaque, and/or half-tone substances may be formed on a layer 120 using any suitable technique, including, but not limited to, printing and/or depositing the substances onto the layer 120. For example, aluminum ink may be opaque and may be printed on a layer 120. In some embodiments, the transparent, opaque, and/or half-tone substances may be colorless, or may exhibit one or more colors.

In some embodiments, a layer 120 may include one or more neutral density filter regions, diffraction grating regions, and/or polarizing regions. In some embodiments, a neutral density filter region may approximately equally modify (e.g., reduce) the intensities of substantially all or most wavelengths (e.g., colors) of visible light passing through the region. In some embodiments, a diffraction grating region may disperse light passing through the region, such that different wavelengths (e.g., colors) of light are diffracted into different beams traveling in different directions. In some embodiments, a polarizing region may impart polarization (e.g., plane polarization, circular polarization, or elliptical polarization) to light that passes through the region.

In some embodiments, a layer 120 may be embossed. Techniques for embossing a layer 120 may include patterning the layer 120, etching the layer 120, printing or depositing a substance (e.g., a transparent, opaque, and/or half-tone substance) on the layer 120 such that substance stands out in relief, and/or another suitable technique. Embossing a portion of a layer 120 which defines graphic content may intensify, accentuate, and/or strengthen the color associated with such a portion of the layer 120. In some embodiments, light that passes through an embossed portion of a layer 120 may exhibit a starburst pattern, striations, or other suitable pattern.

In some embodiments, a layer 120 and/or light guide 101 may include one or more glass beads, reflective materials, and/or other materials. Such beads and/or materials may enhance the light and/or magnify the intensity of light emitted by the light guide. In some embodiments, a layer 120 and/or light guide 101 may include a holographic film or a prism component configured to change the direction of light emitted by light guide 101. Suitable techniques for forming the holographic film or prism component may include, but are not limited to, printing the holographic film or prism onto layer 120 (or light guide 101), and/or stamping layer 120 (or light guide 101) with a foil.

In some embodiments, one or more layers 120 may be flexible and/or elastic. A flexible and/or elastic layer 120 may be configured to bend and/or twist to accommodate routine handling of a magazine or newspaper without breaking or tearing. For example, the Young's modulus of a layer 120 may be less than 0.01 Gpa, between 0.01 GPa and 0.1 GPa, or between 0.1 GPa and 1.0 GPa. In some embodiments, the Young's modulus of a layer 120 may be between 1.0 GPa and 100 GPa, between 100 GPa and 1,000 GPa, or greater than 1,000 GPa. In certain embodiments, the Young's modulus of a layer 120 may be at least 0.001 GPa, at least 0.01 GPa, at least 0.1 GPa, at least 1 GPa, and/or less than 1,000 GPa, less than 100 GPa, or less than 10 GPa.

In some embodiments, two or more components of light-emitting system 300 may be integrated in a same structure (e.g., formed in a same layer of material, formed in one or more layers of a same multi-layer structure, printed on a same layer of material, and/or printed on one or more layers of a same multi-layer structure). The structure may include, but is not limited to, a film (e.g., a thin film) of one or more film layers. In some embodiments, light guide 101 and light source 102 may be integrated. In some embodiments, light guide 101, one or more layers 120, and light source 102 may be integrated. In some embodiments, power source 104 (e.g., printed batteries) and light guide 101 may be integrated.

In some embodiments, light-emitting system 300 or one or more components thereof may be integrated into or attached to any suitable article, including but not limited to a tray, a window, a poster, a wall, a point-of-purchase display, a billboard, an eyeglass frame, a phone (e.g., a mobile phone or smartphone), an electronic device, a fashion accessory (e.g., a purse, handbag, parasol, umbrella, cane, jacket, boot, shoe, cravat, necktie, hat, bonnet, belt, suspender, glove, muff, watch, sash, shawl, scarf, sock, stocking), jewelry (e.g., a brooch, ring, necklace, earring, bracelet, nose ring, lip ring, navel ring), and/or home decor item. Suitable home decor items may include appliances (e.g., refrigerator, freezer, microwave, oven, stove, sink, television), lighting fixtures, plumbing fixtures, floor coverings, window coverings, wall coverings, furniture (e.g., table, chair, bed, sofa, dresser, nightstand), tableware (e.g., forks, spoons, knives and/or other utensils made of any suitable materials, including, but not limited to plastic), etc. In some embodiments, light-emitting system 300 or one or more components thereof may be integrated into or attached to an article of any suitable shape, including, but not limited to, a cube, a cylinder, a sphere, a rectangular prism, etc.

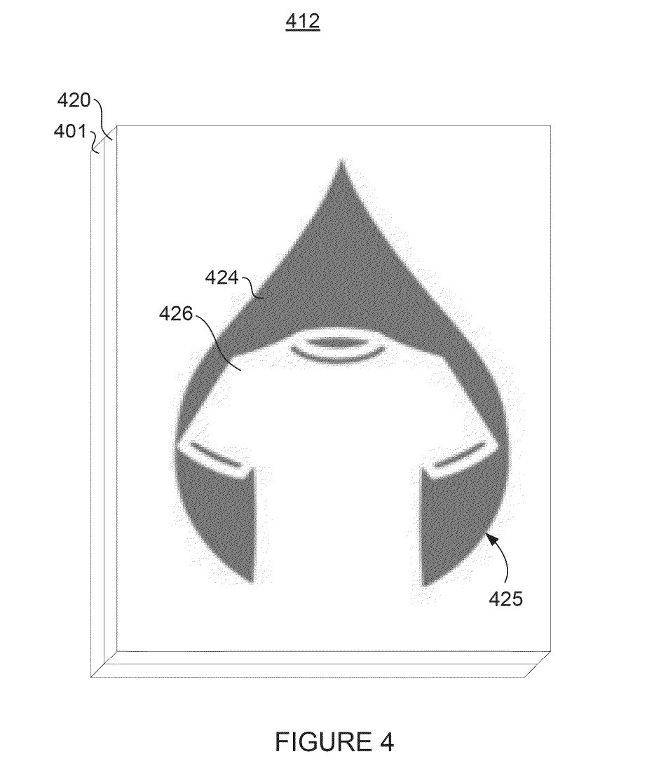

FIG. 4 illustrates an output unit 412 of a light-emitting system, in accordance with some embodiments. In the example of FIG. 4, output unit 412 may be configured to use light emitted by light guide 401 to illuminate graphic content 425 of layer 420. Layer 420 may comprise a tangible publication (e.g., layer 420 may comprise at least a portion of a page of a printed publication). As can be seen, in the example of FIG. 4, layer 420 is disposed above light guide 401 (e.g., adjacent and/or attached to a top surface of light guide 401), such that at least some light emitted from a top surface of light guide 401 propagates through layer 420. In the example of FIG. 4, layer 420 includes graphic content 425, which is formed by an opaque or shaded region 424 and a transparent region 426. In the example of FIG. 4, opaque or shaded region 424 and transparent region 426 define a graphic image of a t-shirt. Though, embodiments are not limited by the nature of graphic content 425. In some embodiments, a light-emitting system may include and/or illuminate any suitable graphic content, including, but not limited to one or more letters, numbers, characters, symbols, images, logos, geometric shapes, words, phrases, likenesses (e.g., of fictional characters or actual people, living or dead), cartoons, structures, and/or objects.

Although the example of FIG. 4 illustrates a single surface of light guide 401 illuminating a single layer 420 disposed above light guide 401, some embodiments are not limited in this regard. In some embodiments, a surface of light guide 401 may illuminate two or more layers 420, including, but not limited to, a stack of layers 420. In some embodiments, two or more surfaces of light guide 401 may illuminate a same layer 420, including, but not limited to, a same layer that wraps around the two or more surfaces. In some embodiments, two or more surfaces of light guide 401 may illuminate two or more respective layers 420 simultaneously and/or at different times.

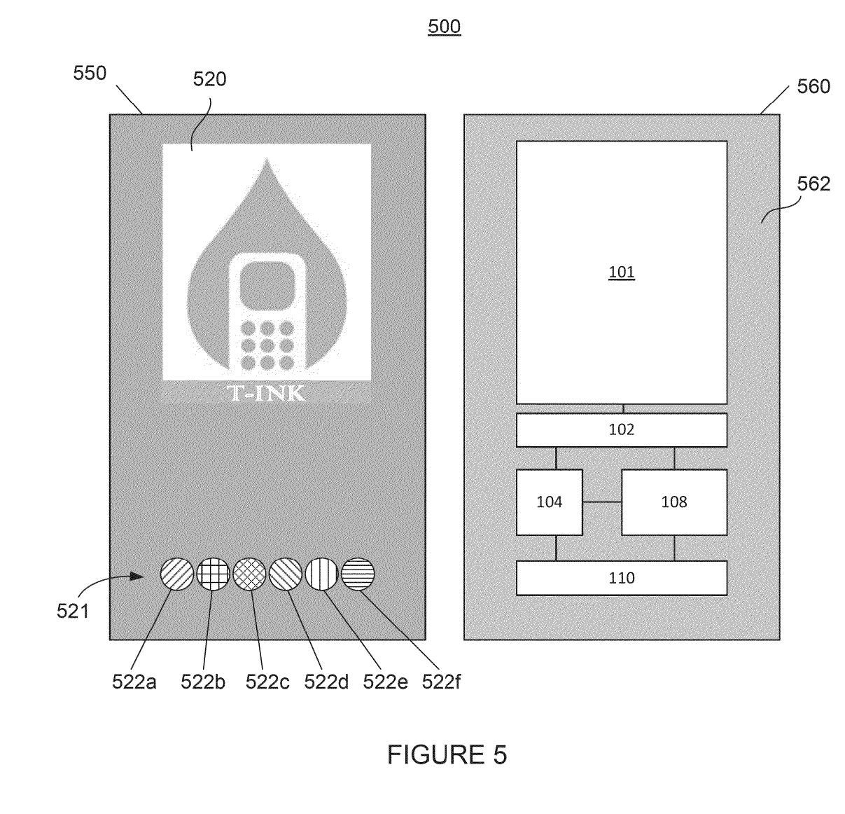

FIG. 5 illustrates a light-emitting system 500 for illuminating graphic content, in accordance with some embodiments. In some embodiments, light-emitting system 500 may form a tangible publication or portion thereof, and may be configured to at least partially illuminate graphic content 520 included in the tangible publication. In some embodiments, light-emitting system 500 may include a first layer 550, a second layer 560, a light guide 101, a light source 102, a power source 104, a computing device 108, and an input unit 110.

Although first layer 550 and second layer 560 are shown separately in FIG. 5, in some embodiments, first layer 550 may be configured to at least partially overlay and attach to second layer 560. In some embodiments, at least a portion of light guide 101 (including, but not limited to, an entirety of light guide 101) may be disposed between first layer 550 and second layer 560. In some embodiments, at least a portion of light guide 101 and at least a portion of light source 102 (including, but not limited to, an entirety of light source 102) may be disposed between first layer 550 and second layer 560. In some embodiments, at least portions of light guide 101, light source 102, and one or more of power source 104, computing device 108, and input unit 110 may be disposed between first layer 550 and second layer 560. In some embodiments, the first and second layers may at least partially surround and/or encapsulate light guide 101 and/or light source 102. In some embodiments, the first and second layers may at least partially surround and/or encapsulate light guide 101, light source 102, and one or more of power source 104, computing device 108, and input unit 110.

In some embodiments, first layer 550 may be attached to second layer 560 along substantially the entirety of the periphery of first layer 550 and/or substantially the entirety of the periphery of second layer 560. Substantially the entirety of the periphery of a layer may be attached to another item when the percentage of the periphery of the layer that is attached to the item exceeds 60%, 70%, 80%, 90%, 95%, or 99%.

First layer 550 and second layer 560 may be attached using any suitable technique. In some embodiments, first layer 550 may be laminated, glued, or stapled to second layer 560. In some embodiments, first layer 550 may be joined to second layer 560 using any suitable adhesive material. In some embodiments, portions of the first and second layers may be directly attached to each other. In some embodiments, portions of the first and second layers may be indirectly attached to each other (e.g., both layers may be attached to a same structure).

In some embodiments, layer 550 may be attached to layer 560 to form a tangible publication or a portion thereof. In some embodiments, layer 550 may be attached to layer 560 such that light guide 101, light source 102, power source 104, computing device 108, and/or input unit 110 may be enclosed and/or surrounded by layers 550 and 560. In some embodiments, layer 550 may be attached to layer 560 such that graphic content 520 and 521 are visible on an outer surface of the publication. In some embodiments, layer 550 may be attached to layer 560 such that graphic content 520 substantially overlays light guide 101, and/or such that graphic content 521 substantially overlays input unit 110. For example, graphic content 521 may overlay input unit 110 such that one or more graphic content items 522a-f substantially overlay one or more respective switches included in input unit 110.

In some embodiments, the average thickness of the tangible publication or portion thereof may be less than or equal to approximately 5 mm, 3 mm, 2 mm, 1 mm, or 0.5 mm. In some embodiments, the average thickness of the tangible publication or portion thereof may be greater than or equal to approximately 0.1 mm.

In some embodiments, light emitted by light guide 101 may illuminate graphic content 520. For example, the regions of graphic content 520 illustrated in white may correspond to transparent regions of layer 550, and light emitted by light guide 101 may pass through these transparent regions. In some embodiments, the regions of graphic content 520 illustrated in non-white may correspond to shaded regions of layer 550 and/or opaque regions of layer 550.

In some embodiments, properties of the light emitted by light guide 101 may be controlled using switches included in input unit 110. In some embodiments, a user may press one or more of graphic content items 522a-522f to activate or deactivate one or more switches overlain by the graphic content items. In some embodiments, in response to activation or deactivation of one or more switches, input unit 110 may send one or more signals to computing device 108 and/or to light source 102. In response to receiving one or more signals from input unit 110, computing device 108 may send one or more signals to light source 102. In response to receiving one or more signals from input unit 110 and/or computing device 108, light source 102 may set or alter (1) one or more properties of the light emitted by light guide 101, including, but not limited to, the light's wavelength, color, intensity, luminance, and/or chromaticity, and/or (2) one or more properties of the color of the light emitted by light guide 101, including, but not limited to the color's hue, tint, shade, tone, saturation, and/or lightness. As just one example, pressing graphic content item 522a may activate an underlying switch, causing input unit 110 and/or computing device 108 to control light source 102 to emit light of a first wavelength and/or color (e.g., green). Pressing other graphic content items 522b-522f may cause light source 102 to emit light of other wavelengths and/or colors.

In some embodiments, in response to receiving one or more signals from input unit 110, computing device 108 may control light source 102 to emit light in accordance with a spatial or temporal pattern (e.g., by initiating a specified sequence of changes in the properties of the emitted light over a specified time period). As just one example, pressing graphic content item 522a may activate an underlying switch, causing computing device 108 to control light source 102 to emit light of a first wavelength and/or color (e.g., green) for a time period (e.g., two seconds), then to emit light of a second wavelength and/or color (e.g., red) for a time period (e.g., three seconds), and to repeat the pattern of alternating wavelengths and/or colors.

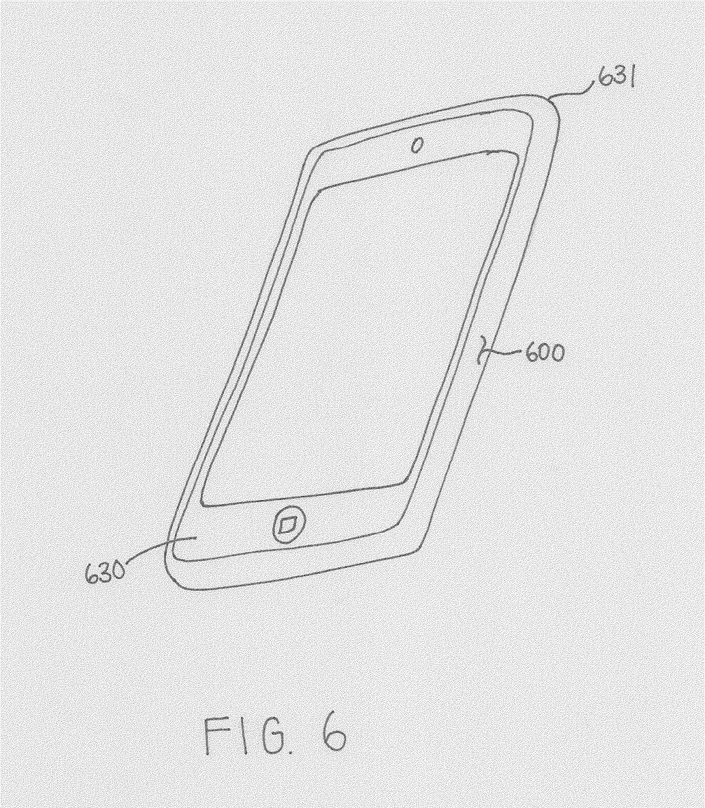

FIG. 6 illustrates a light-emitting system 600 coupled to an article 630, in accordance with some embodiments. In the example of FIG. 6, article 630 is a phone (e.g., a mobile phone or a smartphone). In some embodiments, article 630 may be any article suitable for emitting light, including, but not limited to, a phone, an eyeglass frame, a computing device, a tablet computer, a laptop computer, an electronic device, and/or an automobile. In some embodiments, at least one surface of the article may have at least one contour 631. A contour 631 may include any portion of a surface that is not substantially flat, including, but not limited to, a curve, an edge, a protrusion, and/or a cavity.

In some embodiments, light-emitting system 600 may at least partially overlay at least a portion of article 600. For example, light-emitting system 600 may at least partially overlay at least a portion of a single surface of article 600, or at least portions of two or more surfaces of article 600. In some embodiments, light-emitting system 600 may include a light guide, and the light-emitting system may at least partially overlay at least a portion of an article 600 when at least a portion of the light guide overlays at least a portion of a surface of article 600. In some embodiments, the light guide and a light source may be integrated in a same structure.

In some embodiments, light-emitting system 600 may include an input unit (e.g., one or more switches and/or sensors) configured to control one or more properties of the light emitted by light-emitting system 600. In some embodiments, the input unit and the light guide may be integrated in a same structure. In some embodiments, a user may activate and/or deactivate one or more switches included in the input unit to control a wavelength and/or color of the light emitted by light-emitting system 600.

In some embodiments, at least a portion of light-emitting system 600 may substantially conform to at least a portion of article 630. For example, a contour of at least a portion of a light guide of light-emitting system 600 may substantially match a contour of at least a portion of a surface of article 630. In some embodiments, the contour of a portion of a light guide may substantially match the contour of a portion of a surface of an article when a maximum average spacing between the light guide and the surface of the article over the region in which the light guide overlays the article is less than or equal to approximately a threshold spacing value. Suitable threshold spacing values may include, but are not limited to, 5 mm, 3 mm, 2 mm, 1 mm, 0.5 mm, 0.1 mm, 100% of the thickness of the light guide, 50% of the thickness of the light guide, 25% of the thickness of the light guide, 10% of the thickness of the light guide, and/or 5% of the thickness of the light guide. In some embodiments, at least a portion of the light guide may be in contact with at least a portion of the surface of the article.

In some embodiments, at least a portion of light-emitting system 600 may form at least a portion of a surface of article 630, such that the surface of article 630 comprises at least a portion of light-emitting system 600. For example, the surface of article 630 may comprise at least a portion of a light guide of light-emitting system 600.

In some embodiments, light-emitting system 600 may be configured to emit light having first properties (e.g., a first wavelength and/or color) from a first region of the light-emitting system (e.g., one or more surfaces of the system's light guide, one or more portions of a surface of the light guide, and/or one or more portions of multiple surfaces of the light guide). In some embodiments, light-emitting system 600 may be configured to emit light having first properties (e.g., a first wavelength and/or color) from a first region of the system's light guide and configured to emit light having second properties (e.g., a second wavelength and/or color) from a second region of the light guide. In some embodiments, light-emitting system guide 600 may be configured to emit light having first properties (e.g., a first wavelength and/or color) from a cavity and/or protrusion of the system's light guide and to emit light having second properties (e.g., a second wavelength and/or color) from another portion of the light guide. In some embodiments, such protrusions and/or cavities may substantially match the contour of a surface of article 630.

FIG. 7 shows an illustrative implementation of a computing device 708 suitable for use in connection with some embodiments of a light-emitting system. One or more computing devices such as computer device 708 may be used to implement any of the above-described computing functionality. Computing device 708 may include one or more processors 770; one or more computer-readable storage media (i.e., tangible, non-transitory computer-readable media), e.g., volatile storage 772; and/or one or more non-volatile storage media 774, which may be formed of any suitable non-volatile data storage media. Processor 770 may control writing data to and reading data from volatile storage 772 and/or non-volatile storage 774 in any suitable manner, as aspects of the present disclosure are not limited in this respect. To perform any of the computing functionality described herein, processor 770 may execute one or more instructions stored in one or more computer-readable storage media (e.g., volatile storage 772), which may serve as tangible, non-transitory computer-readable media storing instructions for execution by processor 770. In some embodiments, one or more processors 770 may include one or more processing circuits, including, but not limited to, a central processing unit (CPU), a graphics processing unit (GPU), a field-programmable gate array (FPGA), an accelerator, and/or any other suitable device (e.g., circuit) configured to process data. Although the foregoing discussion describes a “light guide” configured to guide visible light, embodiments are not limited in this regard. It should be appreciated that the techniques described above may be applicable not only to light guides, but also to optical signal guides or optical waveguides configured to guide any suitable optical signals, including, but not limited to, optical signals in the visible spectrum, the infrared spectrum, and/or the ultraviolet spectrum.

In some embodiments, a light-emitting system, including, but not limited to, embodiments of light-emitting systems 300, 400, 500, 600, may further include a component configured to provide sound. In some embodiments, the sound-providing component may play music, speech, and/or any other suitable sounds. In some embodiments, the sound-providing component may synthesize speech. In some embodiments, the sound-providing component may play or synthesize sound in response to signals provided by input unit 110 and/or computing device 108. In some embodiments, the sound-providing component may control the sound such one or more aspects of the sound depends on the wavelength(s) and/or color(s) of light emitted by the light guide.

The phraseology and terminology used herein is for the purpose of description and should not be regarded as limiting. The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A light-emitting system, comprising:
a light source;
a power source configured to provide power to the light source;
a light guide configured to receive and emit at least a portion of the light emitted by the light source; and
a layer disposed adjacent to the light guide and comprising a material defining a graphic image.

2. The system of claim 1, wherein the material comprises a light-inhibiting material.

3. The system of claim 1, wherein the light-emitting system has an average thickness of less than or equal to about 5 mm.

4. The system of claim 1, wherein the light-emitting system has an average thickness of less than or equal to about 3 mm.

5. The system of claim 1, wherein the light-emitting system has an average thickness of less than or equal to about 2 mm.

6. The system of claim 1, wherein the light-emitting system has an average thickness of less than or equal to about 1 mm.

7. The system of claim 1, wherein the light-emitting system has an average thickness of at least about 0.1 mm.

8. The system of claim 1, wherein at least two components selected from the group consisting of the light source, the power source, the light guide, and the layer are formed, respectively, in one or more layers of a structure.

9. The system of claim 1, wherein the light source is electrically, electronically, electromagnetically, optically, and/or mechanically coupled to the light source.

10. The system of claim 1, wherein the system forms at least a portion of a tangible publication.

11. The system of claim 10, wherein the tangible publication comprises at least one tangible publication selected from a group consisting of an advertisement, magazine, newspaper, journal, brochure, flyer, book, and a collection of one or more printed pages.

12. A light-emitting system, comprising:
an article having a contoured external surface;
a light source;
a light guide at least partially overlaying at least a portion of the article and having a shape that substantially matches the contour of the external surface of the underlying article, the light guide configured to receive and emit at least a portion of the light emitted by the light source; and
at least one switch configured such that, when the at least one switch is in a first state, the light guide emits light of a first color and, when the at least one switch is in a second state, the light guide emits light of a second color.

13. The system of claim 12, wherein the article comprises a phone, an eyeglass frame, and/or a computing device.

14. The system of claim 12, wherein at least a portion of the light guide is in contact with the article.

15. A light-emitting system, comprising:
an article having a contoured external surface; and
a light guide at least partially overlaying at least a portion of the article and having a shape that substantially matches the contour of the external surface of the underlying article, the light guide configured to receive and emit at least a portion of the light emitted by a light source integrated with the light guide.

16. The light-emitting system of claim 15, wherein at least a portion of the light guide is in contact with the article.

17-74. (canceled)
